(19) United States
(12) Patent Application Publication
(10) Pub. No.: US 2006/0154217 A1
(43) Pub. Date: Jul. 13, 2006

(54) Globe

(76) Inventor: Andreas Pachler, Egling Aufhofen (DE)

Correspondence Address: SMITH-HILL AND BEDELL, P.C., 16100 NW CORNELL ROAD, SUITE 220, BEAVERTON, OR, 97006, US

(21) Appl. No.: 10/529,025

(22) PCT Filed: Sep. 23, 2003
(86) PCT No.: PCT/DE03/03156

§ 371 Date: Mar. 22, 2005

(30) Foreign Application Priority Data
Sep. 24, 2002 (DE) 102 44 354.8

(51) Int. Cl. G09B 27/08

(52) U.S. Cl. 434/131

(57) ABSTRACT

The invention relates to a globe comprising a contactless and magnetically held globe sphere. Said globe comprises an electric control device for an electromagnet, which is connected on the inlet side thereof to a magnet field sensor, especially a hall-probe, and which controls the position of the glove sphere by switching the electromagnet on an doff or by controlling the current passing through the electromagnet according to the output signals of the magnet field sensor. A microcomputer, which is supplied with the output signal of the magnet field sensor, is provided in order to control a non-oscillating position of the globe sphere. The microcomputer comprises at least one memory-counter which is used to detect on/off positions and /or a device which is used to detect a current passing through the electromagnet or the voltage applied to the electromagnet during at lest one defined period of time. The globe also comprises a switching or controlling device which influences the ration of on and off states of the electromagnets and/or the current flowing through the electromagnet/voltage applied to the electromagnet according to the temporal course of the on/off position detected by the microcomputer and/or measured current/voltage.

The invention relates to a globe including a contactless and magnetically suspended globe sphere as it reads from the preamble of claim 1, it also relating to a method of controlling the position of a magnetically suspended globe sphere in a globe support.

Use is made in such globes of the signal of a magnetic field sensor for energizing and deenergizing an electromagnet mounted on the globe support, whereby the spacing is controlled as follows: substantial for the levitated suspension of the globe sphere in the magnetic field is the permanent magnet on the upper side of the globe sphere. It is this permanent magnet that interacts with the electromagnet mounted on the globe support above the globe sphere. As soon as the globe sphere comes too near to the support, the globe sphere is attracted by means of the permanent magnet to the electromagnet, irrespective of whether it is energized or not. In other words, the spacing of the globe sphere from the globe support must not fall below a certain critical minimum value otherwise the globe sphere will be attracted against the support. The Hall effect sensor senses this spacing of the globe sphere from the magnetic field of the permanent magnet. Thus, attraction of the globe sphere against the support is prevented by the electromagnet being deenergized before the aforementioned critical limit is attained, i.e. before a critical maximum value for the magnetic field and a corresponding output signal of the magnetic field sensor is exceeded.

On the other hand, care must be taken that the spacing of the globe sphere from the support does not become excessive, since, in this case, the average current through the electromagnet needs to be increased which would be a waste of energy and, apart from this, as of a certain spacing the sphere is no longer suspended in the magnetic field and would thus drop out of place. Accordingly, as soon as a certain critical maximum spacing—characterized by the output signal of the magnetic field sensor falling below a certain threshold value—the electromagnet is energized. In other words, the correct spacing of the globe sphere is set by continually energizing/deenergizing the electromagnet as controlled by the output signal of the magnetic field sensor. This device and method respectively functions satisfactorily until circumstances occur in which the system starts to oscillate or resonate as occurs, for example, with oscillations of less than 5 Hz. Tests have shown that the output signal of the magnetic field sensor is of no help in such circumstances, because any greater spacing of the electromagnet of the globe sphere in the Hall effect sensor, as a rule, is compensated by a stronger resulting magnetic field of the electromagnet. Thus, globes known from prior art fail to offer adequate safety from resonant frequencies and oscillations of all kinds.

Another problem is that although energizing/deenergizing the electromagnet as aforementioned suspends the sphere in a relatively safe position, this is not automatically the most favorable position as regards energy consumption. It has thus been discovered, for instance, that just below the critical point at which the globe sphere is attracted to the globe support the energy consumption for suspending the globe sphere is at a minimum. Globes engineered by prior art offer no solution to suspending the globe sphere in a preferred position. In principle it is also possible to control or regulate the position of the globe sphere instead of or in addition to energizing/deenergizing, analagously by the current flow through the electromagnet.

It is thus the object of the invention to provide a globe and a method of controlling the globe sphere in a globe support which now makes it possible to effectively prevent oscillations and resonance whilst suspending the globe sphere safely in the magnetic field with mininum energy consumption. This object is achieved by a globe as it reads from claim 1 and a method as it reads from claim 7. Advantageous aspects of the invention form the subject matter of the corresponding sub-claims.

The invention is based on the applicant having discovered that the magnetic field sensor, as a rule a Hall effect sensor, fails to furnish a satisfactory signal for preventing oscillations and resonance. On the other hand, the applicant has found out that oscillations of the sphere, e,g, due to resonance, are manifested by a change in the ON/OFF ratio, i.e. the duty cycle of the electromagnet when these are sensed over—as compared to the resonant frequency—shorter sensing periods in the range of e.g. 1 to 100 ms, preferably in the range of 5 to 50 ms. Accordingly, the controller of the globe uses by means of the microcontroller or microprocessor the duty cycle of the electromagnet over at least one defined period of time to derive therefrom signals for correcting activation of the electromagnet.

This gist of the invention now makes it possible, as subsequently detailled, not only to prevent oscillations, particularly resonance, but also to set the globe sphere at an ideal spacing relative to the globe support.

For achieving the invention it is irrelevant whether the microcontroller has an input which receives the energizing/deenergizing signals of a switching means for the electromagnet or whether the electromagnet is activated by the microcontroller itself in which case, of course, the switching states are detected in the microcontroller itself.

In a first embodiment of the invention for preventing resonant oscillations the duty cycle is sensed preferably over a shorter period of time of particularly 100 microseconds to 500 milliseconds, preferably 1 to 50 milliseconds and stored in a register. Subsequently the duty cycle is sensed in the next period and stored. From these at least two sensings the change in the duty cycle is computed and this change is used as the basis for outputting control or correction signals for activating the electromagnet. When e.g. the change is positive, in other words the duty cycle of subsequent periods increases, this means that the sphere is being repelled from the globe support, thus requiring the electromagnet to be activated to attract the sphere back. In this case, e.g. positive correction signals can be output, in other words the duty cycle increased over-proportionally to decelerate the sphere stronger than would actually correspond to the values as output by the Hall effect sensor. It is in this way that resonant oscillations are depleted highly effectively. When, on the other hand, a negative change in the duty cycle is sensed over at least two periods in sequence, in other words the sphere is elevated, the energized time can be reduced over-proportionally, i.e. stronger than would correspond to the corresponding output signals of the Hall effect sensor, to prevent oscillations building up in this case, too. It is, of course, just as possible in this context to monitor the change over several e.g. 5 to 50 periods or to use the second derivation, i.e. the change in these changes of the periods in sequence as the basis for outputting the correction signal. In this case, boosting correction or control signals are output preferably then, when the second derivation of the change in the correction signals is positive, in other words when an increase in the positive change in the duty cycle is sensed or should a positive change in the reduction of the duty cycle be sensed.

The microcontroller has preferably a corresponding number of registers and/or counters and a clock with which clocked detection of the energized and/or deenergized status of the electromagnet is achievable, from which the duty cycle is formed as the total over a certain period. Detection can be done e.g. every 10 to 100 microseconds whilst forming the duty cycle can take into account detecting 10 to 1000 clocked sensings.

In addition, the invention enables the current consumption for the globe to be minimized by the duty cycle of the electromagnet being sensed and averaged over a lengthy period of e.g. 500 milliseconds to several seconds and this average compared to a wanted reference value of a duty cycle representing an ideal spacing of the globe sphere from the globe support. This ideal reference duty cycle corresponds to a certain ideal average current flow through the electromagnet which results in a corresponding ideal spacing of the globe sphere just below the point of attraction. The actual duty cycle is altered in the direction of the reference duty cycle so that the globe sphere is steered on an average to an ideal position from the point of view of energy management, i.e. low energy consumption with a correspondingly low increase in temperature of the electromagnet.

It is understood that the technical elements of the invention may be incorporated singly or multiply as called for technically. It is furthermore to be appreciated that electrically activating the electromagnet and the microprocessor may be configured with a variety of elements or in an integrated unit. Preferably the microprocessor comprises the complete means for activating the electromagnet and has, as the input port, merely the digitized output signal of the magnetic field sensor as previously converted in an analog/digital converter.

It is, of course, just as possible to design the basic circuit analogously in which case the time profile of the current flow through the electromagnet or the voltage applied thereto is sensed, from which the control and correcting signals for controlling the electromagnet can be derived. The control in this case can be derived from the duty cycle as well as via the current flow through the electromagnet.

The position in general can in this arrangement be controlled solely via control of current flow through/voltage at the electromagnet or by combined ON/OFF control and also of the current flow through the electromagnet. In this arrangement, e.g. basic duty cycle control and corrective control in avoiding oscillations or for achieving the optimum spacing can be achieved via the current flow.

All sensors as known hitherto and in the future can be used as the magnetic field sensor, preference being given, however, to sensing the magnetic field as a function of the direction. At this time, Hall effect sensors are most popular for sensing the magnetic field.

The invention will now be described by way of example with reference to the diagrammatic drawing in which:

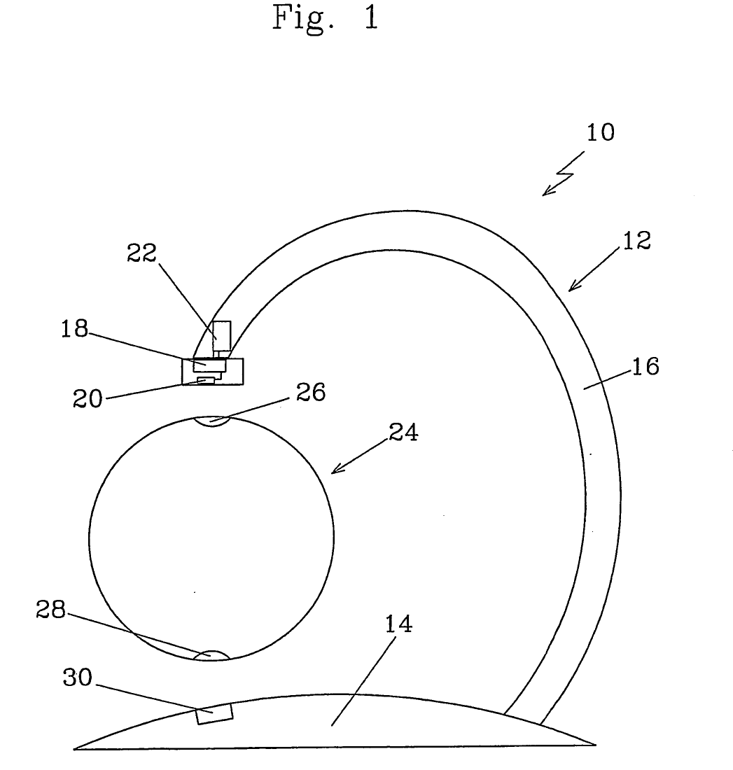

FIG. 1 is a diagrammatic side view of a globe with a levitated sphere,

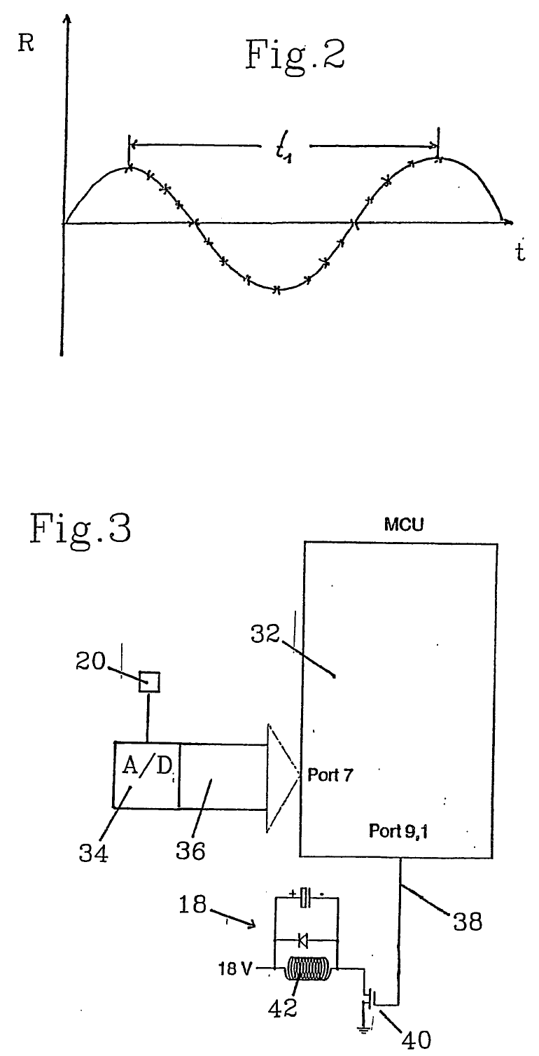

FIG. 2 is a graph plotting the time profile of the duty cycle in the case of a resonant oscillation of the globe sphere, and

FIG. 3 is a circuit in accordance with the invention for preventing resonance and for optimum spacing control in accordance with the invention.

Referring now to FIG. 1 there is illustrated a globe 10 including a globe support 12 comprising a base 14 mounting a vertically curved stand 16. Arranged at the front end of the stand 16 are an electromagnet 18, a Hall effect sensor 20 and an electrical controller 22. The electrical controller 22 may also be arranged at some other location in the globe support 12, e.g. in the base 14, for example in connection with an ON/OFF switch. Suspended levitated under the electromagnet 18 is a globe sphere 24 comprising at its upper side, facing the electromagnet 18, a permanent magnet 26. At its underside the globe sphere 24 includes a second permanent magnet 28 which is, however, simply provided to be held by a third permanent magnet 30 provided in the base 14 of the globe support 12 should the globe sphere 24 drop out of place, to prevent it from rolling away from the base 14 and possibly becoming damaged. The Hall effect sensor 20 detects when a permanent magnet 26 of the globe sphere 24 enters the field of the electromagnet 18. In this case the suspension control comprising the electromagnet 18, the Hall effect sensor 20 and an electrical controller 22 including a microprocessor or microcontroller is activated. The Hall detector permanently furnishes an output signal representative of the distance of the permanent magnet 26 from the electromagnet 18 to the electrical controller 22. If the permanent magnet 26 and thus the globe sphere comes too near to the electromagnet 18, the electrical controller 22 deactivates the electromagnet 18. This results in the globe sphere dipping somewhat as long as the output signal of the Hall effect sensor 20 does not fall below a critical second threshold value, which in turn signals the electrical controller 22 that the electromagnet 18 needs to be re-energized. This results in the globe sphere being reattracted upwards until it reattains the region of the first threshold value at which in turn the electromagnet 18 is again deenergized. Energizing and deenergizing the electromagnet is done at a frequency of several kilohertz e.g. 5 to 10 kHz. Should, for instance, the globe sphere start to oscillate vertically in the course of it entering into the activity range of the device or e.g. due to the wind or some other cause, the duty cycle changes in the scope of an oscillation period t, of, for example, approximately 100 milliseconds, as evident from FIG. 2. In FIG. 2 the duty cycle is plotted as a function of time. Resonant oscillation of the globe sphere results in the duty cycle of the electromagnet becoming sinusoidal.

This curve is obtained as follows: for a certain short period of time, for instance approximately 5 to 15 milliseconds, corresponding to the spacing of the two crosses in the graph as shown in FIG. 2, the energized/deenergized states during each sensing cycle of the microprocessor are totalled in a register or in separate registers. When the microprocessor senses the energized/deenergized status of the electromagnet once every 25 milliseconds, for example, then 40 sensings are made in 10 milliseconds. In these 40 sensings each energized status and each deenergized status, for example, can be counted in separate registers and subsequently the duty cycle thereof obtained or the energized status and deenergized status are totalized in a register, resulting ultimately in a negative or positive value providing information as to the duty cycle. In the course of such an oscillation, as shown in FIG. 2, the duty cycle established as described above changes.

It is this change in the duty cycle or even the second derivation, i.e. an increase or decrease in the change of the duty cycle that can be used as the basis for outputting a correcting value. By making use of these changes in time or second derivations in conventional control programs, the oscillations can be counteracted, e.g. by counteractingly changing the duty cycle towards the end of the oscillations, i.e., as evident from FIG. 2, in the upper and lower reversals of the curve whose ranges of oscillation also correspond to the bobbing of the sphere itself. Thus, by utilizing the highly informative duty cycle of the electromagnet the build-up of oscillations can be effectively prevented by a conventional controller and control algorithms.

In the same way the duty cycle R can also be sensed and averaged over a lengthy period of time e.g. 1 to 10 seconds and compared to a reference value which, so-to-speak for a optimum location of the globe sphere lies just below the point of attraction at which the globe sphere is permanently attracted to the electromagnet 18, it being at this optimum height of the globe sphere that the least energy is consumed. Accordingly, by conventional control algorithms the duty cycle at any one time can be altered in the direction of of the ideal value memorized as the reference value.

Referring now to FIG. 3 there is illustrated a circuit including the controller and the other electrical components of the globe, a microprocessor 32 serving as the controller. The Hall effect sensor 20 as shown in FIG. 1 furnishes its output signal to an analog/digital converter 34 whose digital output signal 36 is supplied to the microprocessor or microcomputer 32. As a function of the output signal of the Hall effect sensor 20 the microprocessor 32 controls energizing/deenergizing the electromagnet 18 via a control line 38 working on the basis of an electronic switch 40, e.g. a transistor which then activates the solenoid 42 located in a resonant circuit of the electromagnet 18.

The microprocessor includes in addition a clock (not shown) and at least one register or counter in which each switching status on the control line 38 is sensed on every cycle, e.g. every 25 milliseconds, resulting in the microprocessor receiving after a number of cycles, e.g. after 10 milliseconds a number, e.g. of 40 sensings which, because of the sensed switching states, represent a value for the duty cycle of the electromagnet. This value is used by the microprocessor to counteract oscillations and to maintain the globe sphere at an optimum spacing as already cited.

1-11. (canceled)

12. A globe comprising
a globe sphere suspended contactless and magnetically, whose position is maintained levitated via a permanent magnet mounted on said sphere, interacting with an electromagnet arranged in connection with a globe support above said sphere,
an electrical controller for said electromagnet and connected at its input end to a magnetic field sensor, particularly a Hall effect sensor, and which controls the position of said globe sphere by energizing/deenergizing said electromagnet or by controlling the current flow through said electromagnet as a function of the output signals of said magnetic field sensor,
characterized in that
a microcomputer is provided, receiving the output signal of said magnetic field sensor,
said microcontroller comprises at least one register/counter for sensing the energized/deenergized status and/or a device for sensing the current flow through, or the voltage at, said electromagnet over at least one defined time period, and that
said globe comprises a switching/control means for influencing the duty cycle of said electromagnet and/or said current flow through, said voltage at, said electromagnet as a function of the time profile of each energized/deenergized status sensed by said microcontroller and/or said sensed current flow/voltage.

13. The globe as set forth in claim 12, characterized in that said microcomputer comprises at least one memory sensing each energized/deenergized status over a lengthy time period of at least 10 ms, preferably 500 ms to 5 s, and a reference value memory for storing a reference duty cycle and that said globe comprises a controlling and/or switching means with which the actual duty cycle of said electromagnet can be influenced in the direction of said reference value.

14. The globe as set forth in claim 12, characterized in that a memory/counter senses each energized/deenergized status over a shorter time period of e.g. 1 to 100 ms, preferably 5 to 50 ms and a comparison circuit or subtraction circuit is provided which senses the change in said duty cycle as compared to previous sensings, and that said globe comprises a controlling and/or switching means with which said actual duty cycle of said electromagnet can be influenced to boost/reduce said change.

15. The globe as set forth in claim 12, characterized in that an analog/digital converter is provided for digitizing the output signal of said magnetic field sensor as the input signal for said microcomputer.

16. The globe as set forth in claim 12, characterized in that said controller comprises a switch for deenergizing said electromagnet as soon as the output signal of said magnetic field sensor drops below a predefined value.

17. The globe as set forth in claim 12, characterized in that said controller comprises a switch for energizing said electromagnet as soon as the output signal of said magnetic field sensor exceeds a predefined value.

18. A method of controlling the position of a globe sphere suspended levitated in a globe support in making use of a permanent magnet in connection with said sphere and interacting with an electromagnet arranged in connection with said globe support above said sphere, comprising
an electrical controller for said electromagnet connected at its input end to a magnetic field sensor, particularly a Hall effect sensor,for detecting the spacing of said permanent magnet from said electromagnet, and to control the position of said globe sphere by energizing/deenergizing said electromagnet or by controlling the current flow through said electromagnet as a function of the output signals of said magnetic field sensor,
characterized in that
each energized/deenergized status of said electromagnet or the current flow through/voltage at said electromagnet is sensed and that from the value of the duty cycle or current or voltage profile or change thereof a signal is derived for controlling and/or correcting activation of said electromagnet.

19. The method as set forth in claim 18, characterized in that said actual duty cycle is compared to a reference value for the wanted duty cycle of said electromagnet from which a signal is derived for controlling and/or correcting said electromagnet.

20. The method as set forth in claim 18, characterized in that the changes in at least two sensings in sequence of said duty cycle are used for deriving a signal for controlling and/or correcting said electromagnet.

21. The method as set forth in claim 18, characterized in that said electromagnet is deenergized as soon as the output signal of said magnetic field sensor falls below a first threshold value.

22. The method as set forth in claim 18, characterized in that said electromagnet is energized as soon as the output signal of said magnetic field sensor exceeds a threshold value.
